(19) United States
(12) Patent Application Publication
(10) Pub. No.: US 2014/0094563 A1
(43) Pub. Date: Apr. 3, 2014

(54) PROCESS FOR MAKING NON-HALOGENATED FLAME RETARDANT POLYMERIC COMPOSITES WITH NANOSTRUCTURES

(71) Applicant: SUNOCS LLC, Valparaiso, IN (US)

(72) Inventors: Cheng Qian Song, Green Brook, NJ (US); Rui Fang Sun, Green Brook, NJ (US); Min Liu, Valparaiso, IN (US); Hui Ling Song, Valparaiso, IN (US)

(73) Assignee: SUNOCS LLC, Valparaiso, IN (US)

(21) Appl. No.: 13/633,854

(22) Filed: Oct. 2, 2012

(51) Int. Cl. C08L 33/02; C08L 35/02; C08K 3/36; C08K 5/529

(52) U.S. Cl. CPC C08L 33/02; C08K 5/529; C08L 35/02; C08K 3/36
USPC 524/707; 524/720; 524/710

(57) ABSTRACT

The present invention generally relates to a process for making non-halogenated flame retardant polymeric composites with superabsorbent polymer coated nanoparticles to provide excellent flame retardant property, low toxicity and high loading efficiency. The flame retardant polymeric composites can be used as flame retarding foams, insulation sheeting materials or other composite materials.

This Invention was made with Government support under EPD12018 awarded by U.S. Environmental Protection Agency. The Government has certain rights in the invention.

### TECHNICAL FIELD

The present invention relates to a process for making non-halogenated flame retardant polymeric composites with superabsorbent polymer coated nanoparticles to provide excellent flame retardant property, low toxicity and high loading efficiency, which can be used as flame retardant foams, insulation sheeting materials or other composite materials.

### BACKGROUND

Most polymer materials are made from hydrocarbons and are readily combustible to cause fire when ignited. Fires destroy billions of dollars of personal property and are especially dangerous to human lives in confined spaces. The conventional method of combating various types of fire has been to apply water to the fire. This procedure has, however, often been ineffective because of the problems associated with the use of water. Due to run-off and evaporation, water is not readily retained on surfaces which are on fire or in danger of catching on fire. Further, this procedure is not effective in preventing the spread of fire to assets at risk, such as houses, structures and cars, which are not initially engulfed by the fire.

Therefore, a widely known method for imparting flame retardancy of the polymeric materials is the addition of a halogen-containing compound with an optional antimony catalyst. The inclusion of a halogen containing compound for flame retardancy may make the resin toxic, especially when the polymeric materials are used in a confined space due to the release of toxic, acetic hydrogen halide gases during combustion. Therefore, non-halogenated compounds for use as flame retardants are desirable.

Other materials, and in particular superabsorbent polymers, have been utilized to attempt to prevent the spread of and combat fires. U.S. Pat. No. 5,849,210 discloses a method of retarding a combustible object from burning comprising applying a mixture of water and a superabsorbent polymer which absorbs at least 20 times its weight in water onto an exposed surface of the combustible object. Superabsorbent polymers do not dissolve or disperse well in the polymeric substrate and therefore, often cause non-homogeneity in the polymeric structure and also swell and impart high viscosity to aqueous mixtures. In addition, superabsorbent polymers are brittle and glassy when dry which further affect the physical properties of the polymeric materials.

Therefore, there is a need for a process to uniformly disperse the superabsorbent polymers together with non-halogenated flame retardants in the polymeric matrix in order to generate a flame retardant polymer composite which has high flame retardancy with low loading of flame retardants and no halogenated substance. It would be particularly advantageous if this composition could be placed on an asset at risk to be protected in advance of contact between the asset and the fire and remain in place under a condition suitable for preventing the spread of the fire to the asset.

Accordingly, it is an object of this invention to produce a superabsorbent polymer coated, non-halogenated nanostructure flame retardant composite materials for preparing coatings, foams, sheets and other structure materials.

### SUMMARY OF THE INVENTION

In accordance with the present invention, non-halogenated, superabsorbent polymer coated nanoparticles and their composites are prepared.

In one embodiment, the present invention relates to a process for making a superabsorbent polymer coated flame retardant comprising:

a) preparing a monomer mixture comprising:

I. about 10.0 to about 50.0 wt % of a first polymerizable monomer;

II. about 0 to about 5.0 wt % of a second polymerizable monomer capable of reacting with the first polymerizable monomer in the presence of free radicals;

III. about 0.1 to about 20.0 wt % of solid particles with a number average particle diameter between about 0.05 and 100 μm;

IV. about 0.1 to about 5.0 wt % of a polymerization initiator capable of producing free radicals;

V. about 0 to about 50.0 wt % of non-halogenated flame retardants capable of improving flame retardant properties of polymeric materials; and

VI. about 0 to about 50.0 wt % of a solvent;

b) reacting the monomer mixture at an elevated temperature under agitation, thereby producing a polymer dispersion; and

c) optionally removing a part of or all of the solvent from the polymer dispersion, thereby producing a polymer coated flame retardant C.

In another embodiment, the present invention relates to a process for making a flame retardant addition polymer composite comprising:

a) preparing a reaction mixture comprising:

I. about 5.0 to about 60.0 wt % of the polymer coated flame retardant C;

II. about 0 to about 50.0 wt % of a first addition monomer capable of forming an addition polymer composite by itself or with other components;

III. about 0 to about 50.0 wt % of a second addition monomer capable of forming an addition polymer composite with the first addition monomer or other components;

IV. optionally, about 0.01 to about 5 wt % of an addition reaction catalyst; and

V. optionally, about 0.1 to about 5 wt % of a surfactant;

b) reacting the reaction mixture at room temperature or an elevated temperature, thereby producing a flame retardant addition polymer composite.

In still another embodiment, the present invention relates to a process for making a flame retardant thermoplastic composite comprising:

a) preparing a polymer blend comprising:

I. about 5.0 to about 60.0 wt % of the polymer coated flame retardant C; and

II. about 40 to about 95 wt % of a thermoplastic polymer; and

b) extruding or blending the polymer blend at an elevated temperature, thereby producing a flame retardant thermoplastic blend; and optionally

c) pelletizing the flame retardant thermoplastic blend, thereby producing a pelletized flame retardant thermoplastic composite.

Preferably, the polymer blend comprises about 7.0 to about 40.0 wt % of the polymer coated flame retardant C. Most preferably, the polymer blend comprises about 10.0 to about 30.0 wt % of the polymer coated flame retardant C.

### DETAILED DESCRIPTION OF THE INVENTION

The present invention relates to a process for making non-halogenated, flame retardant composites. The first polymerizable monomer suitable for this invention can be selected from ethylenically unsaturated monomers. Preferably, the first polymerizable monomer is selected from ethylenically unsaturated, hydrophilic monomers. Most preferably, the first polymerizable monomer is selected from a group consisting of an acrylic acid, acrylamide and their derivatives.

The second polymerizable monomer suitable for this invention can be selected from ethylenically unsaturated, multifunctional monomers. Preferably, the second polymerizable monomer is a multifunctional hydrophilic monomer. Most preferably, the second polymerizable monomer is selected from a group consisting of trimethylopropane triacrylate, trimethylolpropane trimethacrylate, ethoxylated trimethylolpropane triacrylate, propoxylated trimethylolpropane triacrylate, pentaerythritol triacrylate, propoxylated glyceryl triacrylate, ethoxylated pentaerythritol tetraacrylate, ditrimethylopropane tetraacrylate, dipentaerythrtiol, hexaacrylate, and dipentaerythrtiol hexaacrylate and a combination thereof.

The solid particles suitable for this invention are those inorganic or polymeric particles with a number average particle diameter of about 0.05 to about 100 μm. Preferably, those particles have a number average particle diameter of about 0.10 to about 10 μm and are selected from metal oxides. Most preferably, those particles have a number average particle diameter of about 0.10 to about 0.20 μm and are selected from a group consisting of silicon dioxide, magnesium dioxide, titanium oxide, aluminum trioxide and a combination thereof.

The polymerization initiator suitable for this invention is an initiator used for catalyzing the polymerization of the first polymerizable monomer or the mixture of the first polymerizable monomer and the second polymerizable monomer. Preferably, the polymerization initiator is a chemical compound capable of generating free radicals, such as a peroxide compound, including inorganic peroxides, such as, sodium persulfate, potassium persulfate, and organic peroxides, such as, dibenzoyl peroxides; di-tert-butyl peroxide, dicumyl peroxide, cumyl butyl peroxide, 1,1-di-tert-butylperoxy-3,5,5-trimethylcyclohexane, 2,5-dimethyl-2,5-di-tert-butylperoxyhexane, bis(alpha-tert-butylperoxyisopropylbenzene), tert-butylperoxypivalate, tert-butyl perbenzoate, 2,5-dimethyl-hexyl-2,5-di(perbenzoate), tert-butyl di(perphthalate), tert-butylperoxy-2-ethyl hexanoate, 1,1-dimethyl-3-hydroxybutylperoxy-2-ethyl hexanoate, di(2-ethylhexyl)peroxy dicarbonate, di(n-propyl)peroxy dicarbonate, and di(4-tert-butylcyclohexyl)peroxy dicarbonate or an azo compound, such as azobisisobutyronitrile. Two or more initiators having the same or different half-lives may also be employed.

The non-halogenated flame retardants suitable for this invention are those halogen free compounds which will inhibit or retard the flame when added to the polymeric composites. Preferably, the flame retardants are phosphorus or nitrogen containing compounds. Most preferably, the flame retardants are selected from a group consisting of ammonium polyphosphate, melamine cyanurate, melamine polyphosphate, 2-carboxyethyl phenylphosphinic acid, and mixtures thereof.

The solvent suitable for this invention is organic solvents and water. Preferably, the solvent is water.

The first addition monomer suitable for this invention is a monomer with at least two functionalities. Preferably, the first addition monomer is selected from a group consisting of epoxies, isocynates, unsaturated polyethers, unsaturated polyesters, other ethylenically unsaturated monomers and mixtures thereof. Most preferably, the first addition monomer is selected from a group consisting of aliphatic diisocynates, aromatic diisocynates and mixtures thereof.

The second addition monomer suitable for this invention is a monomer with at least two functionalities capable of reacting with the first addition monomer to form addition polymer composites. Preferably, the second addition monomer is selected from a group consisting of amine containing compound, hydroxyl containing compound, and mixtures thereof. Most preferably, the second addition monomer is hydroxyl terminated polyethers.

The addition reaction catalyst is an inorganic or organic transition metal compound capable of catalyzing the reaction of addition monomers. Preferably, the reaction catalyst is an organic tin compound when diisocynates and hydroxyl terminated polyethers are used as the first addition monomer and the second addition monomer, respectively.

The surfactant is a surface active agent which will stabilize the reaction mixture by reducing the interfacial tension of the components of the reaction mixture if these components are not entirely miscible.

The thermoplastic polymer suitable for this invention is a polymer capable of being melt processed at an elevated temperature. Preferably the thermoplastic polymer is selected from copolymers of mono- and di-olefins with other vinyl monomers, for example, ethylene/alkyl acrylate copolymers, ethylene/alkyl methacrylate copolymers, ethylene/vinyl acetate copolymers, ethylene/acrylic acid copolymers and salts thereof (ionomers), and also mixtures thereof. It can also be selected from various polymers, for example polyamides. polystyrene, poly(p-methylstyrene), poly(a-methylstyrene), and other aromatic homopolymers and copolymers derived from vinyl-aromatic monomers, for example styrene, .alpha.-methylstyrene, all isomers of vinyltoluene, all isomers of ethylstyrene, propylstyrene, vinylbiphenyl, vinylnaphthalene, vinylanthracene and mixtures thereof. Also included are stereo block polymers. Copolymers including the already mentioned vinyl-aromatic monomers and comonomers selected from ethylene, propylene, dienes, nitriles, acids, maleic anhydrides, maleic acid amides, vinyl acetate, vinyl chloride and acrylic acid derivatives and mixtures thereof. For example styrene/butadiene, styrene/acrylo-nitrile, styrene/ethylene (interpolymers), styrene/alkyl methacrylate, styrene/butadiene/alkyl acrylate and methacrylate, styrene/maleic anhydride, styrene/acrylonitrile/methyl acrylate; high-impact-strength mixtures consisting of styrene copolymers and another polymer, for example a polyacrylate, a diene polymer or an ethylene/propylene/diene terpolymer; and also block copolymers of styrene, for example styrene/butadiene/styrene, styrene/isoprene/styrene, styrene/ethylene-butylene/styrene or styrene/ethylene-propylene/styrene. Hydrogenated aromatic polymers prepared by hydrogenation of the polymers mentioned above, especially polycyclohexylethylene (PCHE), often also referred to as polyvinylcyclohexane (PVCH), which is prepared by hydrogenation of atactic polystyrene. Hydrogenated aromatic polymers prepared by hydrogenation of the polymers mentioned above. Graft copolymers of vinyl-aromatic monomers, for example styrene on polybutadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned above, such as those known, for example, as so-called ABS, MBS, ASA or AES polymers. Halogen-containing polymers, for example polychloroprene, chlorinated rubber, chlorinated and brominated copolymer of isobutylene/isoprene (halobutyl rubber), chlorinated or chlorosulphonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate. Polymers derived from .alpha.,.beta.-unsaturated acids and derivatives thereof, such as polyacrylates and polymethacrylates, or polymethyl methacrylates, polyacrylamides and polyacrylonitriles impact-resistant-modified with butyl acrylate. Copolymers of the monomers with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers. Polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins. Homo- and co-polymers of cyclic ethers, such as polyalkylene glycols, polyethylene oxide, polypropylene oxide or copolymers thereof with bisglycidyl ethers. Polyacetals, such as polyoxymethylene, and also those polyoxymethylenes which contain comonomers, for example ethylene oxide; polyacetals modified with thermoplastic polyurethanes, acrylates or MBS. Polyphenylene oxides and sulphides and mixtures thereof with styrene polymers or polyamides. Polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; polyamide 6/1 (poly-hexamethylene isophthalimide, MXD (m-xylylenediamine); polyamides prepared from hexamethylenediamine and iso- and/or terephthalic acid and optionally an elastomer as modifier, for example poly-2,4,4-trimethylhexamethylene terephthalamide or poly-m-phenylene isophthalamide. Block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or ABS; and polyamides condensed during processing (“RIM polyamide systems”). Examples of polyamides and copolyamides that can be used are derived from, inter alia, .epsilon.-caprolactam, adipic acid, sebacic acid, dodecanoic acid, isophthalic acid, terephthalic acid, hexamethylenediamine, tetramethylenediamine, 2-methyl-pentamethylenediamine, 2,2,4-trimethylhexamethylenediamine, 2,4,4-trimethylhexamethylenediamine, m-xylylenediamine or bis(3-methyl-4-aminocyclohexyl)methane; and also semi-aromatic polyamides such as polyamide 66/61, for example consisting of 70-95% polyamide 6/6 and 5-30% polyamide 6/1; and also tricopolymers in which some of the polyamide 6/6 has been replaced, for example consisting of 60-89% polyamide 6/6, 5-30% polyamide 6/1 and 1-10% of another aliphatic polyamide; the latter may consist of, for example, polyamide 6, polyamide 11, polyamide 12 or polyamide 6/12 units. Such tricopolymers may accordingly be designated polyamide 66/61/6, polyamide 66/61/11, polyamide 66/61/12, polyamide 66/61/610 or polyamide 66/61/612. Polyureas, polyimides, polyamide imides, polyether imides, polyester imides, polyhydantoins and polybenzimidazoles. Polyesters derived from dicarboxylic acids and dialcohols and/or from hydroxycarboxylic acids or the corresponding lactones, such as polyethylene terephthalate, polypropylene terephthalate, polybutylene terephthalate, poly-1,4-dimethylolcyclohexane terephthalate, polyalkylene naphthalate (PAN) and polyhydroxy-benzoates, and also block polyether esters derived from polyethers with hydroxyl terminal groups; and also polyesters modified with polycarbonates or MBS. Polycarbonates and polyester carbonates. Mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC. More Preferably, the thermoplastic polymer is selected from a group consisting of polyolefins, polyethers, polyaromatics, polyvinyl chloride, polyamide, polysulfones, polyuria, polyurethanes, polycarbonate, polyethylene terephthalate, polybutylene terephthalate, and mixtures thereof. Most preferably, the thermoplastic polymer is a polyolefin selected from:

(a) a crystalline homopolymer of propylene having an isotactic index greater than about 80%, preferably about 90% to about 99.5%;

(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;

(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having an isotactic index greater than about 85%; and

(d) an olefin polymer composition comprising:

(i) about 10% to about 60% by weight, preferably about 15% to about 55%, of a crystalline propylene homopolymer having an isotactic index at least about 80%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and an isotactic index greater than about 60%;

(ii) about 3% to about 25% by weight, preferably about 5% to about 20%, of a copolymer of ethylene and propylene or a C₄-C₈ α-olefin that is insoluble in xylene at ambient temperature; and

(iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;

wherein the total of (ii) and (iii), based on the total olefin polymer composition is about 50% to about 90% by weight, and the weight ratio of (ii)/(iii) is less than about 0.4, preferably 0.1 to 0.3, and the composition is prepared by polymerization in at least two stages;

(e) homopolymers of ethylene;

(f) random copolymers of ethylene and an α-olefin selected from C3-C10 α-olefins having a polymerized α-olefin content of about 1 to about 20% by weight, preferably about 2% to about 16%;

(g) random terpolymers of ethylene and two C₃-C₁₀ α-olefins having a polymerized α-olefin content of about 1% to about 20% by weight, preferably about 2% to about 16%;

(h) homopolymers of butene-1;

(i) paraffin wax;

(j) copolymers or terpolymers of butene-1 with ethylene, propylene or C₅-C₁₀ α-olefin, the comonomer content ranging from about 1 mole % to about 15 mole %; and

(k) mixtures thereof.

Other than in the operating examples, or where otherwise indicated, all numbers, values and/or expressions referring to quantities of ingredients, reaction conditions, etc., used in the specification and claims are to be understood as modified in all instances by the term “about.”

The following examples illustrate the present invention. Unless otherwise indicated in the following examples and elsewhere in the specification and claims, all parts and percentages are by weight, all temperatures are in degrees Celsius, and pressure is at or near atmospheric pressure.

### Example 1

### Synthesis of a Polymer Coated Flame Retardant

Into a 1000 ml four-necked flask were added 100 g of acrylic acid, 300 g of deionized water, 10 g of Sipernat D-13, 300 g of melamine orthophosphate and 5 g of potassium persulfate. The contents of the flask were brought to a temperature of 55 deg. C under agitation for two hours and then cool down to the room temperature to form the polymer coated flame retardant (“E1”). The acrylic acid, melamine orthophosphate, and potassium persulfate were purchased from Sigma-Aldrich. The Sipernat D-13 was purchased from Cytec Industries and deionized water was prepared by using a commercial DI unit comprising a reverse osmosis unit and a mixed bed ion exchange resin polisher.

### Example 2

### Synthesis of a Polymer Coated Flame Retardant

Into a 1000 ml four-necked flask were added 100 g of acrylic acid, 300 g of deionized water, 10 g of Sipernat D-13, 300 g of melamine orthophosphate, 2 g of trimethylopropane triacrylate and 5 g of potassium persulfate. The contents of the flask were brought to a temperature of 55 deg. C under agitation for two hours and then cool down to the room temperature to form the polymer coated flame retardant (“E2”). The acrylic acid, melamine orthophosphate, trimethylopropane triacrylate and potassium persulfate were purchased from Sigma-Aldrich. The Sipernat D-13 was purchased from Cytec Industries and deionized water was prepared by using a commercial DI unit comprising a reverse osmosis unit and a mixed bed ion exchange resin polisher.

### Example 3

### Preparation of a Flame Retardant Addition Polymer Composite

Into a 1000 ml four-necked flask were added 100 g of E1 made by using the method hereinabove in Example 1, 200 g of toluene diisocynate, 0.2 g of 2-ethylhexanoate, and 100 g of 1,6-hexarediol. The contents of the flask were agitated for 2 minutes and then transferred to a rectangular shaped glass container at room temperature in order to prepare samples (“E3”) for flammability test. The toluene diisocynate, 2-ethylhexanoate, and 1,6-hexanediol were purchased from Sigma-Aldrich.

### Example 4

### Preparation of a Flame Retardant Thermoplastic Composite

100 g of E1 made by using the method hereinabove in Example 1 is dried in an oven at temperature of 105 deg. C for one hour. The dried E1 is then mixed with 300 g of propylene polymer premix in a high speed mixer. The propylene polymer premix contains 0.3 wt % of IRGANOX® B 225, 0.5 wt % of zinc stearate and the 99.2 wt % of propylene homopolymer with a MFR of 6.7 dg/min. All the ingredients were commercially available. The mixture is then extruded in a 20 mm twin screw extruder under the following conditions:

Temperature profile: zone 1: 160 deg C, zone 2: 185 deg C, zone 3: 190 deg C, zone 4: 190 deg C; zone 5: 190 deg C, extruder head: 185 deg C.

E3 samples were evaluated under UL94 vertical burn flammability test by subjecting the samples in a flame for 10 seconds in a vertical position.

TABLE I
Flammability of E3 Samples

| Sample No. | after 1^{st} flame (second) | after 2^{nd} flame (second) |
|---|---|---|
| E3-1 | 6 | 8 |
| E3-2 | 4 | 5 |

What is claimed is:

1. A process for making a superabsorbent polymer coated flame retardant comprising:
a) preparing a monomer mixture comprising:
I. about 10.0 to about 50.0 wt % of a first polymerizable monomer;
II. about 0 to about 5.0 wt % of a second polymerizable monomer capable of reacting with the first polymerizable monomer in the presence of free radicals;
III. about 0.1 to about 20.0 wt % of solid particles with a number average particle diameter between about 0.05 and 100 μm;
IV. about 0.1 to about 5.0 wt % of a polymerization initiator capable of producing free radicals;
V. about 0 to about 50.0 wt % of non-halogenated flame retardants capable of improving flame retardant properties of polymeric materials; and
VI. about 0 to about 50.0 wt % of a solvent;
b) reacting the monomer mixture at an elevated temperature under agitation, thereby producing a polymer dispersion; and
c) optionally, removing a part of or all of the solvent from the polymer dispersion, thereby producing a polymer coated flame retardant (“C”).

2. The process according to claim 1 wherein the first polymerizable monomer is an ethylenically unsaturated, hydrophilic monomer.

3. The process according to claim 1 wherein the first polymerizable monomer is selected from a group consisting of acrylic acid, acrylamide and their derivatives.

4. The process according to claim 1 wherein the second polymerizable monomer is a multifunctional hydrophilic monomer.

5. The process according to claim 1 wherein the second polymerizable monomer is selected from a group consisting of trimethylopropane triacrylate, trimethylolpropane trimethacrylate, ethoxylated trimethylolpropane triacrylate, propoxylated trimethylolpropane triacrylate, pentaerythritol triacrylate, propoxylated glyceryl triacrylate, ethoxylated pentaerythritol tetraacrylate, ditrimethylopropane tetraacrylate, dipentaerythrtiol, hexaacrylate, and dipentaerythrtiol hexaacrylate and a combination thereof.

6. The process according to claim 1 wherein the solid particles have a number average particle diameter of about 0.10 to about 10 μm.

7. The process according to claim 6 wherein the solid particles have a number average particle diameter of about 0.10 to about 0.20 μm.

8. The process according to claim 1 wherein the solid particles are selected from a group consisting of silicon dioxide, magnesium-dioxide, titanium oxide, aluminum trioxide and a combination thereof.

9. The process according to claim 1 wherein the polymerization initiator is a chemical compound capable of generating free radicals.

10. The process according to claim 9 wherein the chemical compound is selected from a group consisting of sodium persulfate, potassium persulfate, dibenzoyl peroxides; di-tert-butyl peroxide, dicumyl peroxide, cumyl butyl peroxide, 1,1-di-tert-butylperoxy-3,5,5-trimethylcyclohexane, 2,5-dimethyl-2,5-di-tert-butylperoxyhexane, bis(alpha-tert-butylperoxyisopropylbenzene), tert-butylperoxypivalate, tert-butyl perbenzoate, 2,5-dimethyl-hexyl-2,5-di(perbenzoate), tert-butyl di(perphthalate), tert-butylperoxy-2-ethyl hexanoate, 1,1-dimethyl-3-hydroxybutylperoxy-2-ethyl hexanoate, di(2-ethylhexyl)peroxy dicarbonate, di(n-propyl)peroxy dicarbonate, di(4-tert-butylcyclohexyl)peroxy dicarbonate, azobisisobutyronitrile and mixtures thereof.

11. The process according to claim 1 wherein the non-halogenated flame retardants are selected from phosphorus or nitrogen containing compounds.

12. The process according to claim 1 wherein the non-halogenated flame retardants are selected from a group consisting of ammonium polyphosphate, melamine cyanurate, melamine polyphosphate, 2-carboxyethyl phenylphosphinic acid, and mixtures thereof.

13. A process for making a flame retardant addition polymer composite comprising:
a) preparing a reaction mixture comprising:
I. about 5.0 to about 60.0 wt % of a polymer coated flame retardant C; wherein the polymer coated flame retardant C is made by a process comprising:
x) preparing a monomer mixture comprising:
i. about 10.0 to about 50.0 wt % of a first polymerizable monomer;
ii. about 0 to about 5.0 wt % of a second polymerizable monomer capable of reacting with the first polymerizable monomer in the presence of free radicals;
iii. about 0.1 to about 20.0 wt % of solid particles with a number average particle diameter between about 0.05 and 100 μm;
iv. about 0.1 to about 5.0 wt % of a polymerization initiator capable of producing free radicals;
v. about 0 to about 50.0 wt % of non-halogenated flame retardants capable of improving flame retarding properties of polymeric materials; and
vi. about 0 to about 50.0 wt % of a solvent;
y) reacting the monomer mixture at an elevated temperature under agitation, thereby producing a polymer dispersion; and
z) optionally, removing a part of or all of the solvent from the polymer dispersion, thereby producing a polymer coated flame retardant C;
II. about 0 to about 50.0 wt % of a first addition monomer capable of forming an addition polymer composite by itself or with other components;
III. about 0 to about 50.0 wt % of a second addition monomer capable of forming an addition polymer composite with the first monomer or other components;
IV. optionally, about 0.01 to about 5 wt % of an addition reaction catalyst; and
V. optionally, about 0.1 to about 5 wt % of a surfactant;
b) reacting the reaction mixture at room temperature or an elevated temperature, thereby producing a flame retardant addition polymer composite.

14. The process according to claim 13 wherein the first addition monomer is selected from a group consisting of epoxies, isocynates, unsaturated polyethers, unsaturated polyesters and mixtures thereof.

15. The process according to claim 13 wherein the second addition monomer is selected from a group consisting of amine containing compound, hydroxyl containing compound, and mixtures thereof.

16. The process according to claim 13 wherein the addition reaction catalyst is an organic tin compound.

17. A process for making a flame retardant thermoplastic composite comprising:
a) preparing a polymer blend comprising:
I. about 5.0 to about 60.0 wt % of a polymer coated flame retardant C; wherein the polymer coated flame retardant C is made by a process comprising:
x) preparing a monomer mixture comprising:
i. about 10.0 to about 50.0 wt % of a first polymerizable monomer;
ii. about 0 to about 5.0 wt % of a second polymerizable monomer capable of reacting with the first polymerizable monomer in the presence of free radicals;
iii. about 0.1 to about 20.0 wt % of solid particles with a number average particle diameter between about 0.05 and 100 μm;
iv. about 0.1 to about 5.0 wt % of a polymerization initiator capable of producing free radicals;
v. about 0 to about 50.0 wt % of non-halogenated flame retardants capable of improving flame retardant properties of polymeric materials; and
vi. about 0 to about 50.0 wt % of a solvent;
y) reacting the monomer mixture at an elevated temperature under agitation, thereby producing a polymer dispersion; and
z) optionally, removing apart Of or all of the solvent from the polymer dispersion, thereby producing a polymer coated flame retardant C;
II. about 40 to about 95 wt % of a thermoplastic polymer; and
b) extruding or blending the polymer blend at an elevated temperature, thereby producing a flame retardant thermoplastic blend; and optionally
c) pelletizing the flame retardant thermoplastic blend, thereby producing a pelletized flame retardant thermoplastic composite.

18. The process according to claim 17 wherein the thermoplastic polymer is an olefin polymer.

19. The process according to claim 18 the olefin polymer is selected from a group consisting of:
(a) a crystalline homopolymer of propylene having an isotactic index greater than about 80%, preferably about 90% to about 99.5%;
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;
(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having an isotactic index greater than about 85%; and
(d) an olefin polymer composition comprising:
(i) about 10% to about 60% by weight, preferably about 15% to about 55%, of a crystalline propylene homopolymer having an isotactic index at least about 80%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and an isotactic index greater than about 60%;
(ii) about 3% to about 25% by weight, preferably about 5% to about 20%, of a copolymer of ethylene and propylene or a C₄-C₈ α-olefin that is insoluble in xylene at ambient temperature; and
(iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, preferably 0.1 to 0.3, and the composition is prepared by polymerization in at least two stages;
(e) a homopolymer of propylene having solubility in xylene at room temperature higher than about 20% by weight;
(f) homopolymers of ethylene;
(g) random copolymers of ethylene and an α-olefin selected from C3-C10 α-olefins having a polymerized α-olefin content of about 1 to about 20% by weight, preferably about 2% to about 16%;
(h) random terpolymers of ethylene and two C₃-C₁₀ α-olefins having a polymerized α-olefin content of about 1% to about 20% by weight, preferably about 2% to about 16%;
(i) homopolymers of butene-1;
(j) paraffin wax;
(k) copolymers or terpolymers of butene-1 with ethylene, propylene or C₅-C₁₀ α-olefin, the comonomer content ranging from about 1 mole % to about 15 mole %; and
(l) mixtures thereof.
